(19) United States
(12) Patent Application Publication
(10) Pub. No.: US 2022/0306333 A1
(43) Pub. Date: Sep. 29, 2022

(54) MEDIA FEED CONTROL FOR A LABEL APPLICATOR

(71) Applicant: Panduit Corp., Tinley Park, IL (US)

(72) Inventors: Andrew R. Hays, Cumming, GA (US); Kevin L. Nelson, Cumming, GA (US)

(73) Assignee: Panduit Corp., Tinley Park, IL (US)

(21) Appl. No.: 17/706,769

(22) Filed: Mar. 29, 2022

Related U.S. Application Data
(60) Provisional application No. 63/167,327, filed on Mar. 29, 2021.

(51) Int. Cl. B65C 9/44; B65C 9/18; B65C 3/02

(52) U.S. Cl. CPC B65C 9/44; B65C 9/1865; B65C 3/02; B65C 2009/404

(57) ABSTRACT

An object label applicator is provided for the accurate labeling of labels onto objects within a wrapping mechanism of the object label applicator. The object label applicator includes a media feed control solution for detecting whether a label has successfully detached from its lining, and if it is detected that the label has not detached from the lining, a remedial measure is implemented to increase the likelihood of detachment in a subsequent run.

### CROSS-REFERENCE TO RELATED APPLICATION(S)

This application claims benefit to U.S. Provisional Patent Application No. 63/167,327, filed on Mar. 29, 2021, the entirety of which is hereby incorporated by reference herein.

### TECHNICAL FIELD

This disclosure is related to a label application device, system and method that includes a media feed control solution for ensuring proper detachment of a label from its release liner so that the label may be placed onto its intended object.

### BACKGROUND

Most label applicators rely on the column strength of a label substrate to overcome the bond strength of its pressure sensitive adhesive to a release liner, as the liner is pulled around a sharp bend (e.g., peeling plate). As the label travels with the liner, the bond is broken first, as the leading edge of the label reaches the location of the sharp bend. The column strength of the label substrate pushes the edge of the label straight, and the adhesive (which is bonded to the label substrate) is unable to maintain its bond to the liner.

However, the bond strength between the adhesive and the liner may vary, and there are instances where the label fails to peel off its liner with just a single pass over the sharp bend. Such “failure-to-peel” situations result in the label failing to attach onto its intended object, as the label remains on the liner and travels around and past the peeling plate. The conditions resulting in the failure-to-peel situation tend to increase in frequency as the label-substrate media ages due to the adhesive bond between the adhesive and the liner increases with age. The failure-to-peel situation may also tend to increase in frequency at slightly elevated temperatures, where the column strength of the substrate decrease.

### SUMMARY

This disclosure relates to a wire guide assembly for a label applicator that provides for the accurate labeling of objects by including a media feed control solution for properly breaking the adhesive bond of a label to its liner so that the label may be placed onto its intended object.

According to some embodiments, a label applicator is disclosed, wherein the label applicator comprises a label detection sensor, a memory configured to store machine-readable instructions, and a processor in communication with the memory. The processor is configured to execute the machine-readable instructions to control a media feeding mechanism to advance a media in a first direction, wherein the media includes a label adhered to a liner, receive a label signal from the label detection sensor, control the media feeding mechanism to retract the media in a second direction based on the label signal, wherein the second direction is a reverse direction from the first direction, and control the media feeding mechanism to advance the media in the first direction.

### BRIEF DESCRIPTION OF THE DRAWINGS

To understand the present disclosure, it will now be described by way of example, with reference to the accompanying drawings in which:

FIG. 1 is a side view of a label applicator, according to an embodiment.

FIG. 2A is a magnified view of an Area A of the label applicator shown in FIG. 1, according to an embodiment.

FIG. 2B is a magnified view of an Area A of the label applicator shown in FIG. 1, according to an embodiment.

FIG. 2C is a magnified view of an Area A of the label applicator shown in FIG. 1, according to an embodiment.

FIG. 3 is a perspective view of a label media being fed according to a media feed control solution, according to an embodiment.

FIG. 4 is a perspective view of a label media being fed in a forward feeding direction according to a media feed control solution, according to an embodiment.

FIG. 5 is a perspective view of the label media being fed in a backward feeding direction according to the media feed control solution, according to an embodiment.

FIG. 6 is a perspective view of the label media being fed in the forward feeding direction according to the media feed control solution, according to an embodiment.

FIG. 7 is a perspective view of the label media continuing to be fed in the forward feeding direction according to the media feed control solution, according to an embodiment.

FIG. 8 is a flow chart describing the media feed control solution, according to an embodiment.

FIG. 9 is a flow chart describing the media feed control solution, according to an embodiment.

FIG. 10 is a system block diagram for a computer system's architecture that is included in the label applicator, according to an embodiment.

### DETAILED DESCRIPTION

While the described features are provided for embodiments in many different forms, there is shown in the drawings and will herein be described in detail preferred embodiments with the understanding that the present disclosure is to be considered as an exemplification of the principles of the features and is not intended to limit the broad aspect of the features to the embodiments illustrated.

As required, detailed embodiments are disclosed herein; however, it is to be understood that the disclosed embodiments are merely exemplary of the inventive features that may be embodied in various and alternative forms that include additional, or fewer, components and/or steps. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The disclosed label applicator solves or improves upon one or more disadvantages with presently known label applicators. The present label applicator implements a media feed control solution that provides for the accurate labeling of objects when using a label media that includes a label adhered to a liner. In particular, the media feed control solution accounts for the unwanted situations where the label fails to break its adhesive bond to its liner and therefore fails to be attached to its intended object.

Referring generally to the figures, automated apparatuses for applying printed labels to wires, cables or other elongated objects of varying diameters are illustrated. The disclosure references an exemplary elongated object label application, where labels are wrapped around the objects without spinning the objects about their elongated longitudinal axes. The apparatuses are particularly useful for label types that require the label be wrapped around an object using more than one revolution. Self-laminating labels are one such type, requiring a transparent end of the label to be wrapped over top of a printed region to provide protection to the printed content. Once such example of a label applicator is disclosed in U.S. patent application Ser. No. 16/279,298, which is incorporated by reference here in its entirety. Another example of a label applicator is disclosed in U.S. patent application Ser. No. 17/121,957, which is incorporated by reference here in its entirety. Another example of a label applicator is disclosed in U.S. patent application Ser. No. 16/507,708, which is incorporated by reference here in its entirety.

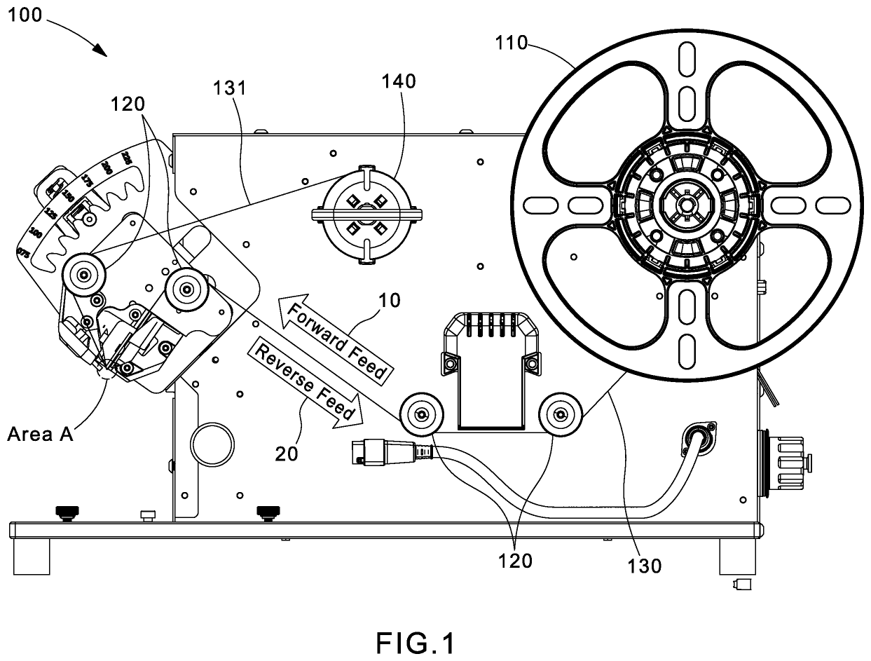

While the present description is provided by referencing the label applicator system shown in FIG. 1, the media feed control solution is applicable to other types of label applicator devices or systems where a label media is used to apply a label onto an object. For example, the media feed control solution may be implemented on an assembly line system using the label media, where labels are intended to be attached to products, product packaging, and/or shipping boxes. The media feed control solution looks to solve the issue where a label fails to break its adhesive bond with its liner to be attached to its intended object.

Turning to the drawings, FIG. 1 illustrates a label applicator 100. The label applicator 100 includes a label spool 110 that holds and dispenses a label media 130, as will be described. The label media 130 is comprised of a liner 131 and a label 132, where the label 132 is adhered to the liner 131 with an adhesive, and the adhesive bond between the label 132 and the liner 131 is intended to break for applying the label onto another object at a detachment point along a media feed path.

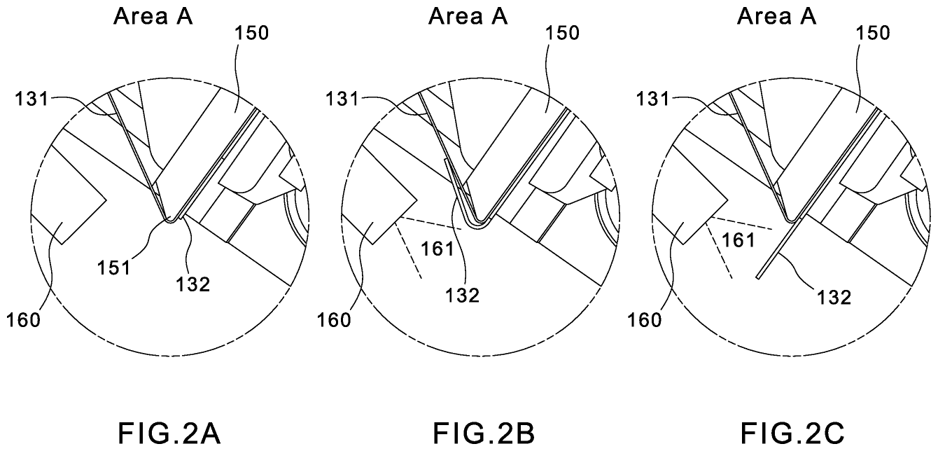

The label spool 110 is rotated, either in a forward feeding direction 10 or a reverse feed direction 20, via a motor that is controlled according to the media feed control solution described herein. Under a normal feeding operation, the label media 130 is fed out from the label spool 110 in the forward feed direction 10 and routed using a number of guide rollers 120 to a label application location (Area A). The label media 130 approaches the application location (Area A) along the media feed path, where the label 132 is intended to detach from the liner 131 and applied to its intended object at a detachment point within the application location (Area A). The detachment point may be at, or near, an edge of peeling plate 150, as shown in FIGS. 2A-2C. Following detachment of the label 132 from the liner 131 at the detachment point, the leftover liner 131 is fed back along a liner return path to a liner return spool 140.

FIGS. 2A-2C show a magnified view of the application location (Area A) during a label detachment sequence where the media feed control solution is applied by the label applicator 100, according to some embodiments. As shown in FIG. 2A, the label application 100 further includes the peeling plate 150 and a label detection sensor 160. The peeling plate 150 is made from a metal or other hard material, and includes an edge 151 that provides a bend around which the label media 130 is routed around to break the adhesive bond between the label 132 and the liner 131 (i.e., the edge 151 coincides with the detachment point). In other words, the bend occurs at the label application point where the media feed path interchanges into the liner return path.

The label detection sensor 160 is positioned at a sensor location that is downstream the media feed path, where the field of view 161 of the label detection sensor 160 is able to detect the presence of the label 132 when it has successfully detached from the liner 131, as shown, for example, in FIG. 2C. From its position downstream the media feed path, the label detection sensor 160 is also able to detect within its field of view 161 the absence of the label 132 when the label 132 remains attached to the liner 131 past the edge 151 of the peeling plate 150 (i.e., the detachment point), as shown, for example, in FIG. 2B.

In FIG. 2A, the label 132 is shown to be traveling in the forward feed direction 10 along the media feed path as it approaches the detachment point at the edge 151 of the peeling plate 150. At this position, the label presence sensor is detecting no labels within its field of view 161, which is within the expected operation of the label applicator 100.

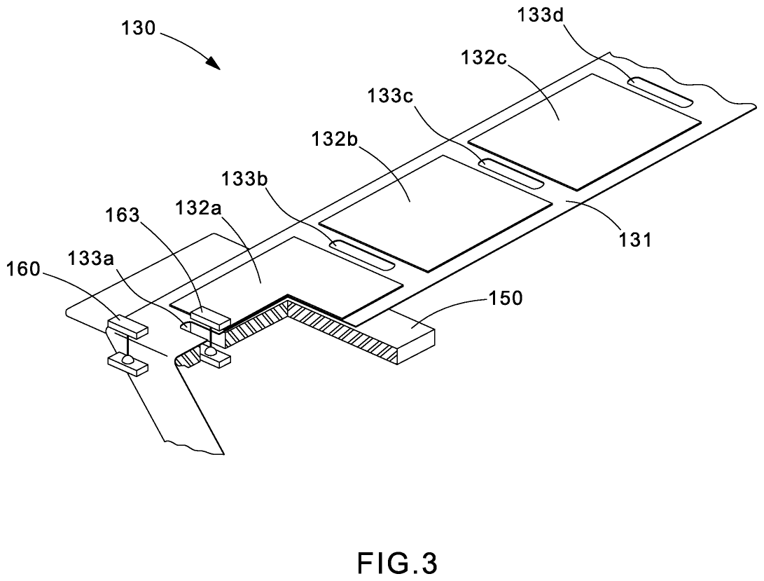

Then in FIG. 2B, the label 132 is shown to have passed through the detachment point without successfully detaching from the liner 131. The label detection sensor 160 still does not detect the label 132 in FIG. 2B, which is outside the expected operation of the label applicator 100 when the label 132 is known to have traveled past the detachment point. A more detailed description for how the label applicator 100 determines the location of the label 132 is provided in more detail with reference to FIGS. 3-7 below. Following the determination that the label 132 remains attached to the liner 131 past the detachment point, the label applicator 100 controls the media feeding mechanism (e.g., the label spool 110) to reverse direction and retract the label media 130 in the reverse feed direction 20 until at least the front edge of the label 132 retreats back behind the detachment point and behind the edge 151 of the peeling plate 150.

Then in FIG. 2C, the label applicator 100 controls the media feeding mechanism to change direction again to feed the label media 130 back in the forward feed direction 10 to travel past the edge 151 of the peeling plate 150 a second time. This subsequent pass over the edge 151 of the peeling plate 150 works to further break the adhesive bond between the label 132 and the liner 131, such that the label 132 breaks the adhesive bond and detaches successfully from the liner 131. So in FIG. 2C the label 132 is shown successfully detached from the liner 131, and the label detection sensor 160 now detects the label 132 within its field of view 161. The label applicator 100 determines operation may continue to a next label application step when the label detection sensor 160 is able to detect the label 132. If the label detection sensor 160 is not able to detect the label 132 following the media feed control step, the media feed control step may be repeated.

Alternatively (not shown), the label detection sensor 160 may be positioned at a sensor location that is downstream the liner return path to detect when the label 132 has remained on the liner 131 past the detachment point.

The label detection sensor 160 may be an image sensor configured to capture an image within its field of view 161. Alternatively, the label detection sensor 160 may be a motion detection sensor configured to detect when the label 132 comes into its field of view 161, a break-beam sensor arrangement having two parts (e.g., one for emitting light and one for receiving the light) that detects when the label 132 breaks a plane of the light beam, as shown, for example, in FIGS. 3-7. According to some embodiments, the label detection sensor 160 may be a reflective sensor where light emitted from the sensor is directed out towards an object to be detected, and when the light is reflected back to the sensor from a reflection off the object, this indicates the object is present.

FIGS. 3-7 show exemplary states of the label applicator 100 as it implements the media feed control solution while feeding the label media 130, according to some embodiments. FIG. 3 shows a perspective view of a portion of the label media 130 as it is being fed through the label applicator 100, where only limited components of the label applicator 100 are shown to illustrate how the media feed control solution may be applied to other label application systems.

In the embodiments illustrated by FIGS. 3-7, the label applicator 100 is shown to include the label detection sensor 160, as well as a liner position sensor 163 (e.g., a home sensor), where the liner position sensor 163 is configured to detect slots that are positioned on the liner 131 at locations between successive labels, and/or detect the presence of the labels 132 themselves, as they pass underneath the liner position sensor 163. By detecting and tracking specific slots on the liner 131, the label applicator 100 can accurately determine how to control the feeding, and retracting, movements of the label media 130 (e.g., a distance) during its media feed control solution, as described in more detail below. The liner position sensor 163 was not previously expressly illustrated.

Further, according to the embodiments illustrated by FIGS. 3-7, both the label detection sensor 160 and the liner position sensor 163 are shown to be beam-break types of sensors having a two-part emitter/receiver pair system. A first part of the beam-break sensor is a light emitter (e.g., infrared light emitter) that emits light to a second part of the beam-break sensor which is a light receiver. The light emitted from the light emitter is received by the light receiver unless the light path is blocked by a sufficiently opaque interrupter (e.g., object such as the label 132). The detected interruption by the beam-break sensor when the interrupter passes through the light path between the light emitter and the light receiver may be determined by the label applicator 100 to be when the label 132 and/or parts of the liner 131 are detected. The liner slots 133 may be detected when the beam-break sensor is allowed to emit light all the way through to the light receiver, indicating a hole (i.e. slot) in the label media 130. One or more of the label detection sensor 160 or the liner position sensor 163 may be configured to also operate in a reflective mode where the light emitter and the light receiver are positioned on a same side of the label media 130 and spaced apart a distance so that light emitted from the light emitter may reflect off the label media 130 and be received by the light receiver. In other embodiments, the label detection sensor 160 and the liner position sensor 163 may be any combination of the same, or different, types of sensors capable of detecting the label 132 and the liner slots 133.

As shown in FIG. 3, the liner 131 includes slots 133a-133d that are located between successive labels 132a-132-c. The state of the label media 130 shown by FIG. 3 may be referred to as a home position for a first label 132a that is the next label to be peeled from the liner 131 and applied to an object. In this home position, the label detection sensor 160 is also not detecting the first label 132a and the liner position sensor 163 is detecting a first slot 133a in the liner 131, where the first slot 133a is positioned directly in front of the first label 132a in the forward feed direction 10 (i.e., the first slot 133a is considered the home slot for the first label 132a).

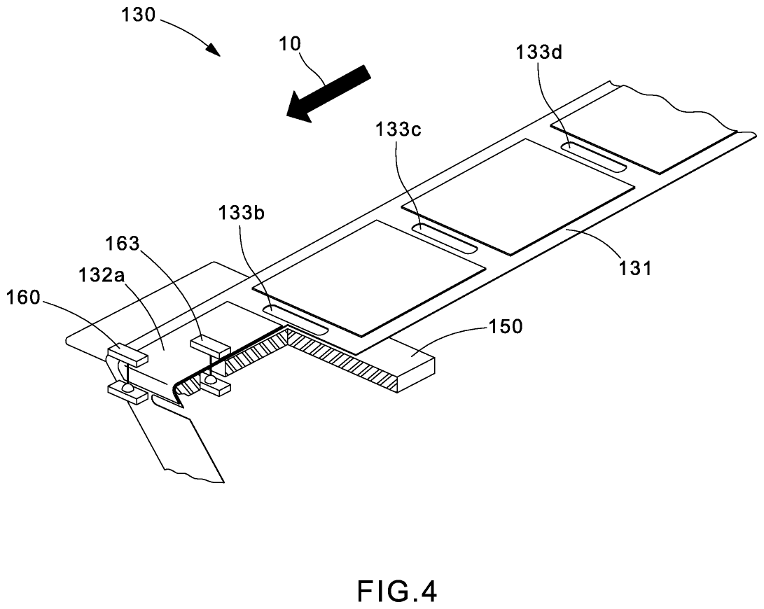

FIG. 4 shows a failure state where the first lab el 132a has failed to detach from the liner 131. When this happens, the first label 132a continues with the liner 131 along the liner return path past the detachment point as the label applicator 100 feeds the label media in the forward feed direction 10. As the first label 132a remains on the liner 131, the label detection sensor 160 does not detect the first label 132a. Also in the failure state shown in FIG. 4, the liner position sensor 163 detects the first lab el 132a (i.e., the label to be peeled) as it passes underneath the liner position sensor 163. As the label detection sensor 160 does not detect the first label 132a after the first slot 133a has passed under the liner position sensor 163, the label applicator 100 may determine that the first label 132a has failed to peel off the liner 131. The label applicator 100 may confirm that the first label 132a has failed to peel off the liner 131 when the label detection sensor 160 fails to detect the first label 132a and the first slot 133a is detected to have passed under the liner position sensor 163. In addition or alternatively, the label applicator 100 may confirm that the first label 132a has failed to peel off the liner 131 when the label detection sensor 160 fails to detect the first label 132a and a predetermined amount of time has transpired after the first slot 133a is detected to have passed under the liner position sensor 163, a predetermined distance is traveled by the label media 130 after the first slot 133a is detected to have passed under the liner position sensor 163, or the liner position sensor 163 detects the second slot 133b (i.e., the next slot).

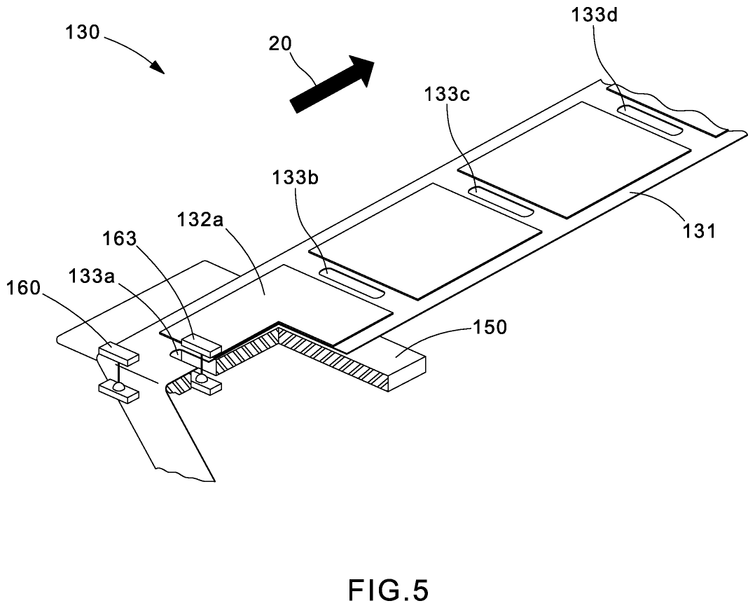

Upon determining that the first label 132a has failed to detach from the liner 131, the label applicator 100 implements its media feed control solution by reversing the feeding direction of the label media 130 to re-run the first label 132a over the edge of the peeling plate 150. FIG. 5 shows the label media 130 being reversed and moving in the reverse feed direction 20. Under the media feed control solution, the label applicator 100 will move the label media 130 in the reverse feed direction 20 until the first slot 133a is detected again by the liner position sensor 163. In addition or alternatively, the label applicator 100 may move the label media 130 in the reverse feed direction 20 until a predetermined amount of time has transpired or a predetermined distance is traveled by the label media 130.

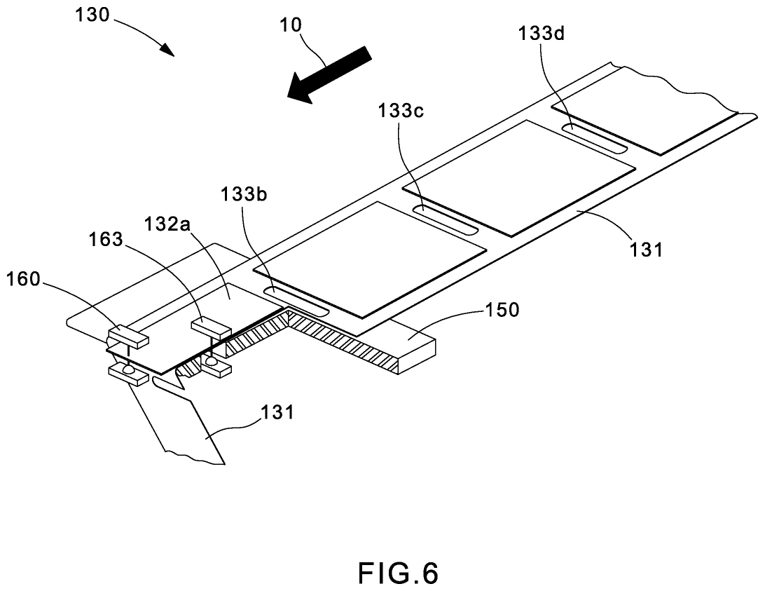

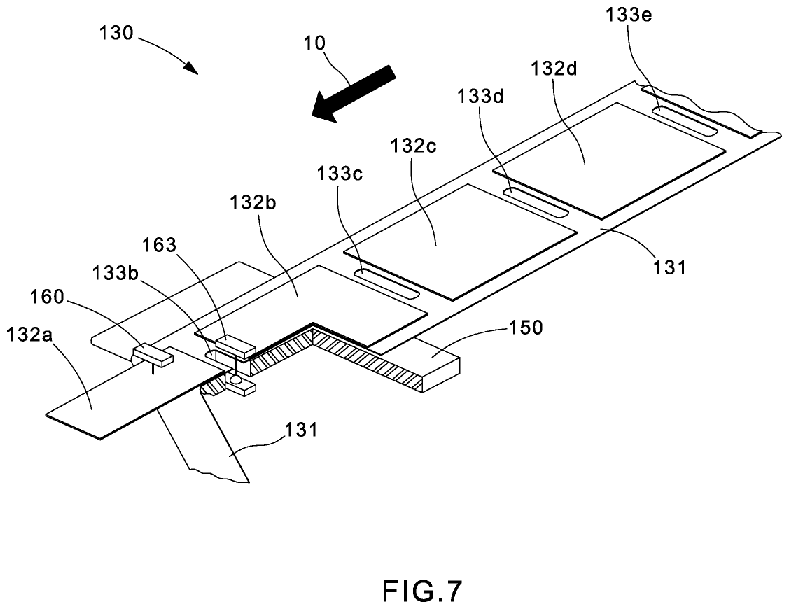

After ceasing movement of the label media 130 in the reverse feed direction 20, the label applicator 100 reverts to moving the label media 130 in the forward feed direction 10. When successful, this jogging sequence will have the front of the first label 132a move over the edge of the peeling plate 150 a subsequent time and create enough breaking force to break the adhesive bond between the first label 132a and the liner 131 so that the first label 132a peels off the liner 131, as shown in FIG. 6. When the first label 132a peels off the liner 131, the first label 132a will continue traveling in the media feed path to fall within the field of view 161 of the label detection sensor 160. By detecting the first label 132a using the label detection sensor 160, the label applicator 100 determines the first label 132a has now successfully detached from the liner 131 and operation may continue to peel the next label (e.g., the second label 132b), as shown by the operational state illustrated in FIG. 7. If the label detection sensor 160 still fails to detect the first label 132a, the remedial steps for reversing the feed direction to re-run the front portion of the first label 132a over the edge of the peeling plate 150 may be repeated under the media feed control solution until successful peeling is achieved. In addition or alternatively, other remedial steps may be implemented such as ceasing operation and/or transmitting a message to a user identifying the failed state.

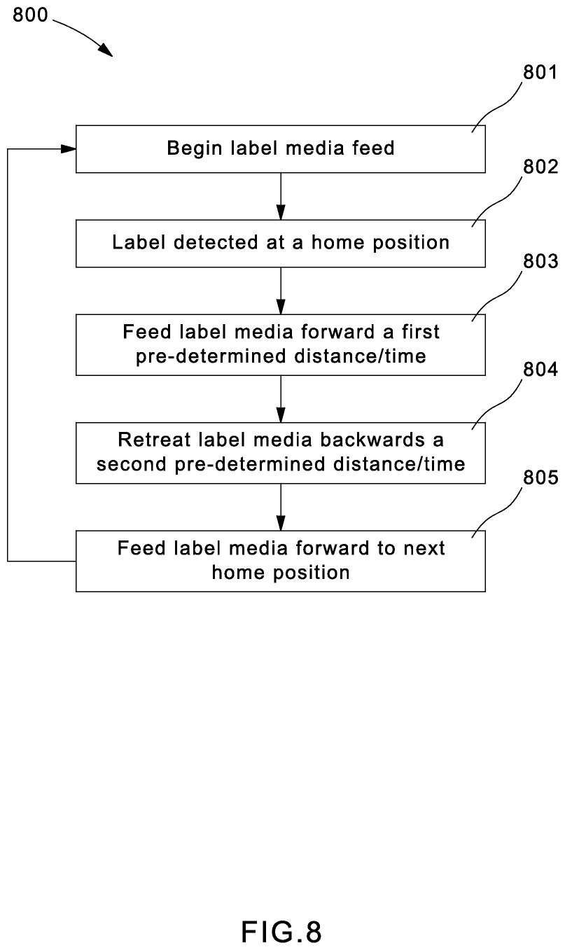

FIG. 8 shows a flow chart 800 describing an exemplary process representative of the media feed control solution described herein, according to some embodiments. The process may be implemented using software, hardware, and/or circuitry of the label applicator 100.

At 801, the label applicator 100 beings to feed the label media in the forward feed direction 10.

While the label media is being fed in the forward feed direction, at 802 a label is detected to be in a home position (e.g., label to be peeled), according to an embodiment described herein.

At 803, the label media is moved forward in the forward feed direction 10 for a first predetermined distance, where the first predetermined distance is selected to ensure the front portion of the label to be peeled passes over the edge 151 of the peeling plate 150 as it moves in the forward feed direction 10. Alternatively, the label media may be moved forward in the forward feed direction 10 for a first predetermined amount of time, where the first predetermined amount of time is selected to ensure the front portion of the label to be peeled passes over the edge 151 of the peeling plate 150 as it moves in the forward feed direction 10.

At 804, the label media is moved backward in the reverse feed direction 20 fora second predetermined distance, where the second predetermined distance is selected to ensure the front portion of the label to be peeled passes back behind the edge 151 of the peeling plate 150 as it moves in the reverse feed direction 20. Alternatively, the label media may be moved backward in the reverse feed direction 20 for a second predetermined amount of time, where the second predetermined amount of time is selected to ensure the front portion of the label to be peeled passes back behind the edge 151 of the peeling plate 150 as it moves in the reverse feed direction 20.

At 805, the label media 130 is moved forward in the forward feed direction 10 to address the next label to be peeled.

The remedial jogging process described by the flow chart 800 is applied quickly to each label 132 on the label media 130 to increase the probability that each label 132 will successfully peel of its liner 131 to be applied to its intended object. In other words, the media feed control solution described by the flow chart 800 does not inspect whether each label 132 has detached from its liner 131, but instead applies the remedial jogging steps to each label 132 on the label media 130. This solution may be more efficient and save resources, while still achieving the goal of increasing the probability that each label 132 will successfully peel of its liner to be applied to its intended object. Furthermore, the media feed control solution described by flow chart 800 is implemented to have a predictable execution time, which may be desired for some applications where sequential timing is needed for completion (e.g. having a known execution time for wrapping a label on sequential cable objects).

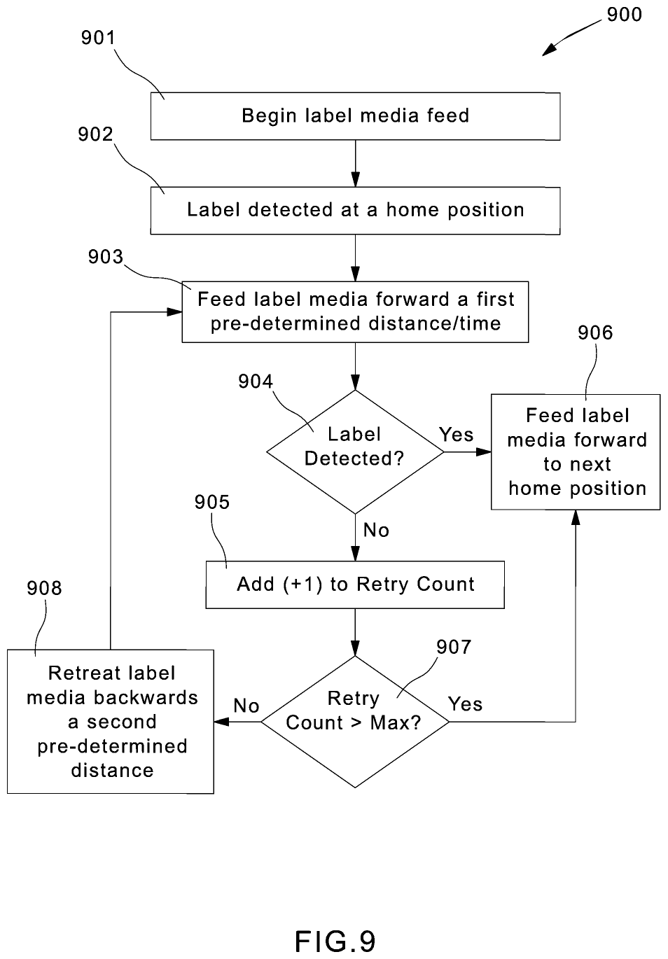

FIG. 9 shows a flow chart 900 describing an exemplary process representative of the media feed control solution described herein, according to some embodiments. The process may be implemented using software, hardware, and/or circuitry of the label applicator 100.

At 901, the label applicator beings to feed the label media in the forward feed direction 10.

While the label media is being fed in the forward feed direction, at 902 a label is detected to be in a home position (e.g., label to be peeled), according to an embodiment described herein.

At 903, the label media is moved forward in the forward feed direction 10 for a first predetermined distance, where the first predetermined distance is selected to ensure the front portion of the label to be peeled passes over the edge 151 of the peeling plate 150 as it moves in the forward feed direction 10. Alternatively, the label media may be moved forward in the forward feed direction 10 for a first predetermined amount of time, where the first predetermined amount of time is selected to ensure the front portion of the label to be peeled passes over the edge 151 of the peeling plate 150 as it moves in the forward feed direction 10.

At 904, the label applicator 100 determines whether the label detection sensor 160 has detected the label to be peeled at its position along the media feed path. If the label to be peeled is determined to have been detected by the label detection sensor 160, then at 906 the media feed control solution determines the label to be peeled has successfully peeled and the label media 130 continues to be fed in the forward feed direction 10 to address peeling of the next label 132.

However, if the label to be peeled is determined not to have been detected by label detection sensor 160, then at 905 a retry count is iterated higher by the label applicator 100, and then at 907 the label applicator 100 determines whether a maximum retry count has been exceeded.

If the maximum retry count has not been exceeded, then at 908 the label media is moved backward in the reverse feed direction 20 for a second predetermined distance, where the second predetermined distance is selected to ensure the front portion of the label to be peeled passes back behind the edge 151 of the peeling plate 150 as it moves in the reverse feed direction 20. Alternatively, the label media may be moved backward in the reverse feed direction 20 for a second predetermined amount of time, where the second predetermined amount of time is selected to ensure the front portion of the label to be peeled passes back behind the edge 151 of the peeling plate 150 as it moves in the reverse feed direction 20. Then following the reverse jogging process at 908, the label applicator 100 reverts to moving the label media 130 back in the forward feed direction 10 to re-run the label to peeled over the peeling plate 150.

The remedial jogging back and forth of the front portion of the label to be peeled over the edge of the peeling plate 150 continues until the label to be peeled is detected by the label detection sensor 160, thus indicating successful peeling of the label off its liner 131, or until the maximum retry count is exceed.

The remedial jogging process described by the flow chart 900 is applied when the label to be peeled is determined to have failed peeling of its liner 131, thus providing a more targeted media feed control solution than the one described in flow chart 800, although the execution time may be variable compared to the predictable execution time of the media feed control solution described in flow chart 800. Even so, both embodiments of the media feed control solution result in the increased probability that each label 132 will successfully peel of its liner 131 to be applied to its intended object.

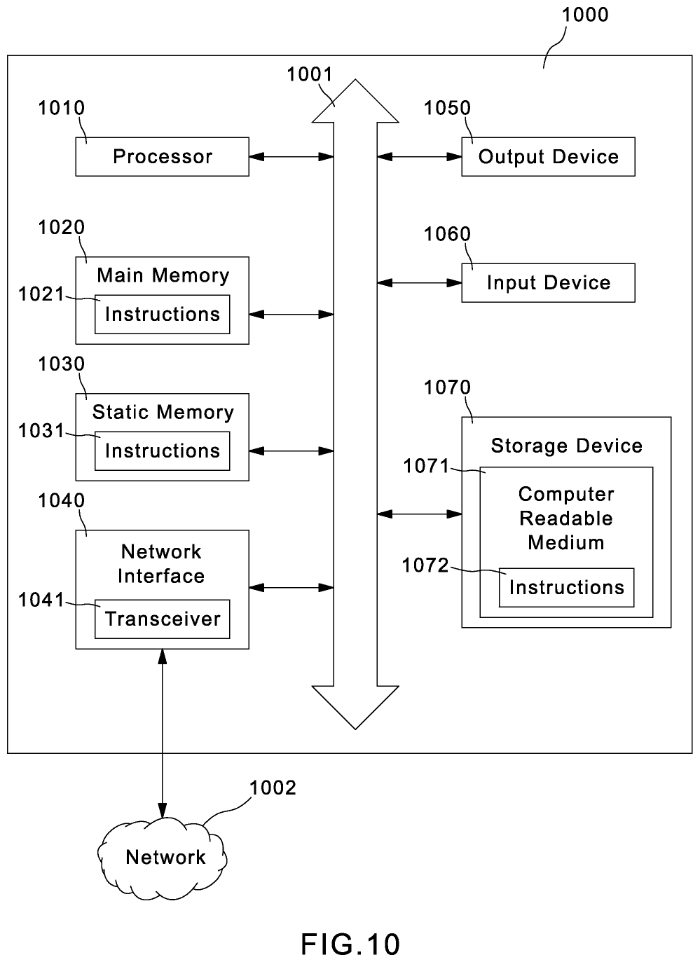

FIG. 10 illustrates an exemplary computer architecture for a computing device system 1000 included in the label applicator 100, or alternatively, in remote communication with the label applicator 100. Although not specifically illustrated, the computing device system 1000 may additionally include software, hardware, and/or circuitry for implementing attributed features as described herein.

The computing device system 1000 includes a processor 1010, a main memory 1020, a static memory 1030, an output device 1050 (e.g., a display or speaker), an input device 1060, and a storage device 1070, communicating via a bus 1001. The bus 1001 may represent one or more busses, e.g., USB, PCI, ISA (Industry Standard Architecture), X-Bus, EISA (Extended Industry Standard Architecture), or any other appropriate bus and/or bridge (also called a bus controller).

The processor 1010 represents a central processing unit of any type of architecture, such as a CISCO (Complex Instruction Set Computing), RISC (Reduced Instruction Set Computing), VLIW (Very Long Instruction Word), or a hybrid architecture, although any appropriate processor may be used. The processor 1010 may further be a microprocessor. The processor 1010 executes instructions 1021, 1031, 1072 stored on one or more of the main memory 1020, static memory 1030, or storage device 1070, respectively. The processor 1010 may also include portions of the computing device system 1000 that control the operation of the entire computing device system 1000. The processor 1010 may also represent a controller that organizes data and program storage in memory and transfers data and other information between the various parts of the computing device system 1000.

The processor 1010 is configured to receive input data and/or user commands through input device 1060 or received from a network 1002 through a network interface 1040. Input device 1060 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computing device system 1000 and control operation of computing device system 1000 such as user input buttons on the label applicator 100.

The processor 1010 may also communicate with other computer systems via the network 1002 to receive control commands or instructions 1021, 1031, 1072, where processor 1010 may control the storage of such control commands or instructions 1021, 1031, 1072 into any one or more of the main memory 1020 (e.g., random access memory (RAM)), static memory 1030 (e.g., read only memory (ROM)), or the storage device 1070. The processor 1010 may then read and execute the instructions 1021, 1031, 1072 from any one or more of the main memory 1020, static memory 1030, or storage device 1070. The instructions 1021, 1031, 1072 may also be stored onto any one or more of the main memory 1020, static memory 1030, or storage device 1070 through other sources. The instructions 1021, 1031, 1072 may correspond to, for example, instructions for implementing the media feed control solution described herein.

Although the computing device system 1000 is represented in FIG. 10 as a single processor 1010 and a single bus 1001, the disclosed embodiments applies equally to computing device system that may have multiple processors and to computing device system that may have multiple busses with some or all performing different functions in different ways.

The storage device 1070 represents one or more mechanisms for storing data. For example, the storage device 1070 may include a computer readable medium 1071 such as read-only memory (ROM), RAM, non-volatile storage media, optical storage media, flash memory devices, and/or other machine-readable media. In other embodiments, any appropriate type of storage device may be used. Although only one storage device 1070 is shown, multiple storage devices and multiple types of storage devices may be present. Further, although the computing device system 1000 is drawn to contain the storage device 1070, it may be distributed across other computer systems that are in communication with the computing device system 1000, such as a server in communication with the computing device system 1000. For example, when the computing device system 1000 is representative of a mobile device (e.g., smartphone), the storage device 1070 may be distributed across to include a cloud storage platform.

The storage device 1070 may include a controller (not shown) and a computer readable medium 1071 storing instructions 1072 capable of being executed by the processor 1010 to carry out control for feeding of the label media 130, as described herein. In another embodiment some, or all, the functions are carried out via hardware in lieu of a processor-based system. In some embodiments, the included controller is a web application browser, but in other embodiments the controller may be a database system, a file system, an electronic mail system, a media manager, an image manager, or may include any other functions capable of accessing data items.

The output device 1050 is configured to present information to the user. For example, the output device 1050 may be a display such as a liquid crystal display (LCD), a gas or plasma-based flat-panel display, or a traditional cathode-ray tube (CRT) display or other well-known type of display that may, or may not, also include a touch screen capability. Accordingly, the output device 1050 may function to display a graphical user interface (GUI), operational information, or messages to the user, as described herein. In other embodiments, the output device 1050 may be a speaker configured to output audible information to the user. In still other embodiments, any combination of output devices may be represented by the output device 1050.

Computing device system 1000 also includes the network interface 1040 that allows communication with other computers via the network 1002, where the network 1002 may be any suitable network and may support any appropriate protocol suitable for communication to/from computing device system 1000. In an embodiment, the network 1002 may support wireless communications. In another embodiment, the network 1002 may support hard-wired communications, such as a telephone line or cable. In another embodiment, the network 1002 may support the Ethernet IEEE (Institute of Electrical and Electronics Engineers) 802.3x specification. In another embodiment, the network 402 may be the Internet (e.g., the Internet 1 illustrated in FIG. 1) and may support IP (Internet Protocol). In another embodiment, the network 1002 may be a LAN (e.g. AV LAN 2 illustrated in FIG. 1) or a wide area network (WAN). In another embodiment, the network 1002 may be a hotspot service provider network. In another embodiment, network 1002 may be an intranet. In another embodiment, the network 1002 may be a GPRS (General Packet Radio Service) network. In another embodiment, the network 1002 may be any appropriate cellular data network or cell-based radio network technology. In another embodiment, the network 1002 may be an IEEE 802.11 wireless network. In another embodiment, the network 1002 may be representative of an Internet of Things (IoT) network. In still another embodiment, the network 1002 may be any suitable network or combination of networks. Although one network 1002 is shown in FIG. 4, the network 1002 may be representative of any number of networks (of the same or different types) that may be utilized.

The network interface 1040 provides the computing device system 1000 with connectivity to the network 1002 through any compatible communications protocol. The network interface 1040 sends and/or receives data from the network 1002 via a wireless or wired transceiver 1041. The transceiver 1041 may be a cellular frequency, radio frequency (RF), infrared (IR), Bluetooth, or any of a number of known wireless or wired transmission systems capable of communicating with the network 1002 or other computer device having some or all of the features of the computing device system 1000. The network interface 1040 as illustrated in FIG. 10 may be representative of a single network interface card configured to communicate with one or more different data sources. Furthermore, the network interface 1040 may be representative of AV related communication ports such as high-definition multimedia interface (HDMI), DisplayPort, or mini DisplayPort (MDP), as well as data communication ports such as ethernet, universal serial bus (USB), power over ethernet (POE), or single pair ethernet (SPE).

The computing device system 1000 may be implemented using any suitable hardware and/or software, such as a personal computer or other electronic computing device. In addition, the computing device system 1000 may also be a smartphone, portable computer, laptop, tablet or notebook computer, PDA, appliance, IP telephone, server computer device, AV gateway, MQTT broker, or mainframe computer.

While the specific embodiments have been illustrated and described, other modifications may be applied without significantly departing from the spirit of the disclosure, and the scope of protection is only limited by the scope of the accompanying claims.

What is claimed is:

1. A label applicator comprising:
a label detection sensor;
a memory configured to store machine-readable instructions; and
a processor in communication with the memory, the processor configured to execute the machine-readable instructions to:
control a media feeding mechanism to advance a media in a first direction, wherein the media includes a label adhered to a liner;
receive a label signal from the label detection sensor;
control the media feeding mechanism to retract the media in a second direction based on the label signal, wherein the second direction is a reverse direction from the first direction; and
control the media feeding mechanism to advance the media in the first direction.

2. The label applicator of claim 1, wherein the processor is configured to execute the machine-readable instructions to:
control the media feeding mechanism to retract the media in the second direction for a predetermined distance.

3. The label applicator of claim 1, wherein the processor is configured to execute the machine-readable instructions to:
control the media feeding mechanism to retract the media in the second direction for a predetermined length of time.

4. The label applicator of claim 1, wherein the label detection sensor is positioned to capture an image at a downstream location that is downstream along a media feed path such that the label detection sensor is configured to capture an absence of the label at the downstream location to indicate the label has not detached from the liner.

5. The label applicator of claim 1, wherein the label detection sensor is positioned to capture an image at a downstream location that is downstream along a liner return path such that the label detection sensor is configured to capture a presence of the label at the downstream location to indicate the label has not detached from the liner.

6. The label applicator of claim 1, wherein the processor is further configured to execute the machine-readable instructions to:
receive a subsequent label signal from the label detection sensor;
determine the subsequent label signal indicates the label has detached from the liner; and
control the media feeding mechanism to continue advancing the media in the first direction.

7. The label applicator of claim 1, further comprising:
a media home sensor configured to capture an image at a slot detection location; and
wherein the lining includes a first media slot in front of the label in the first direction and a second media slot behind the label in the second direction.

8. The label applicator of claim 7, wherein media home sensor is configured to:
capture a first image of the first media slot when the first media slot passes through the slot detection location as the media feeding mechanism advances the media in the first direction;
capture a second image of the first media slot when the first media slot passes through the slot detection location as the media feeding mechanism advances the media in the second direction; and
wherein the processor is configured to execute the machine-readable instructions to control the media feeding mechanism to retract the media in the second direction until receiving a media signal from the media home sensor corresponding to the second image.

9. The label applicator of claim 1, wherein the label detection sensor is an image sensor.

10. The label applicator of claim 1, further comprising:
a wrapping assembly including a wrapping mechanism comprising:
a plurality of guide rollers spaced about a central portion; and
a belt tensioned around the plurality of guide rollers and positioned across an opening in the central portion through which an object to be labeled is received; and
a wire guide assembly disposed on a side of the wrapping assembly, the guide assembly comprising:
a body portion including a first slide and a second slide, the first slide and the second slide respectively located on distal ends of the body portion, wherein the first slide and the second slide are configured to interact with a respective first rail and a second rail included on the wrapping assembly;
guide posts disposed on a top end of the body portion, the guide posts configured to receive an object for labeling; and
a switch configured to actuate the wrapping mechanism.

11. The label applicator of claim 1, further comprising:
a wrapping assembly including a wrapping mechanism configured to place a label on an object through an opening at a central portion;
a wire guide assembly comprising:
a body portion including a housing cavity storing a spring;
guide posts disposed on a top end of the body portion, the guide posts configured to receive the object for labeling at the central portion; and
a switch configured to actuate the wrapping mechanism.

12. A non-transitory machine readable memory in communication with a processor, the non-transitory machine readable memory comprising instructions that, when executed by the processor, are configured to cause the processor to:
control a media feeding mechanism of a label applicator to advance a media in a first direction, wherein the media includes a label adhered to a liner;
receive a label signal from a label detection sensor;
control the media feeding mechanism to retract the media in a second direction based on the label signal, wherein the second direction is a reverse direction from the first direction; and
control the media feeding mechanism to advance the media in the first direction.

13. The non-transitory machine readable memory of claim 12, further comprising instructions that, when executed by the processor, are configured to cause the processor to:
control the media feeding mechanism to retract the media in the second direction for a predetermined distance.

14. The non-transitory machine readable memory of claim 12, further comprising instructions that, when executed by the processor, are configured to cause the processor to:
control the media feeding mechanism to retract the media in the second direction for a predetermined length of time.

15. The non-transitory machine readable memory of claim 12, wherein the label detection sensor is positioned to capture an image at a downstream location that is downstream along a media feed path such that the label detection sensor is configured to capture an absence of the label at the downstream location to indicate the label has not detached from the liner.

16. The non-transitory machine readable memory of claim 12, wherein the label detection sensor is positioned to capture an image at a downstream location that is downstream along a liner return path such that the label detection sensor is configured to capture a presence of the label at the downstream location to indicate the label has not detached from the liner.

17. The non-transitory machine readable memory of claim 12, further comprising instructions that, when executed by the processor, are configured to cause the processor to:
receive a subsequent label signal from the label detection sensor;
determine the subsequent label signal indicates the label has detached from the liner; and
control the media feeding mechanism to continue advancing the media in the first direction.

18. The non-transitory machine readable memory of claim 12, wherein the label detection sensor is an image sensor.
